(19) United States
(12) Patent Application Publication
(10) Pub. No.: US 2009/0194132 A1
(43) Pub. Date: Aug. 6, 2009

(54) DENTAL FLOSSER HAVING MULTI-TEXTURE FLOSS

(76) Inventors: Russell G. Kalbfeld, Naperville, IL (US); David L. Barcus, Elmhurst, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/363,997

(22) Filed: Feb. 2, 2009

Related U.S. Application Data
(60) Provisional application No. 61/024,959, filed on Jan. 31, 2008.
(60) Provisional application No. 61/024,955, filed on Jan. 31, 2008.

(51) Int. Cl. A61C 15/04

(52) U.S. Cl. 132/323; 29/896.1

(57) ABSTRACT

A dental flosser having a handle and a pair of spaced apart arms. A length of dental floss having distinct segments of varying textures extends between the spaced apart arms. A first segment is relatively smooth and is used for insertion and withdrawal of the floss into/from the spaces between adjacent teeth. A second segment is textured and is used for removing plaque and other debris from the spaces between adjacent teeth.

### CROSS REFERENCE TO RELATED APPLICATION

This application claims the benefit of and priority to U.S. Provisional Patent Application Nos. 61/024,959 and 61/024,955, both filed on Jan. 31, 2008. The entire contents of each of the foregoing applications are hereby incorporated by reference herein.

This application is related to U.S. patent application Ser. No. 12/355,497, filed Jan. 16, 2009, the entire contents of which are hereby incorporated by reference herein.

### BACKGROUND OF THE INVENTION

The present invention relates to dental flossers.

Dental flossing devices are known for simplifying the flossing process for certain users. Reusable flossers generally include a handle, a pair of spaced apart arms, and a floss retention device. One end of a length of floss is connected to the floss retention device and the floss is strung between the spaced apart arms. The opposite end of the floss is then connected to the floss retention device. A user can then floss using the handle to manipulate the portion of the floss between the arms into the spaces between his or her teeth.

Disposable flossers are also known. Disposable flossers are generally formed of an inexpensive plastic material and also include a handle and a pair of spaced apart arms. In most disposable flossers, the length of floss extending between the arms is integrally molded with the flosser body during manufacturing and cannot be replaced. Disposable flossers are generally discarded after a single use.

Flossers, particularly disposable flossers, must utilize flosses that are strong, thin, and smooth so the same relatively short piece of floss can be used for flossing the entire mouth. While many flosses provide the desired durability characteristics, such flosses do not remove plaque and other debris as well as certain other flosses. For example, some flosses are designed to be relatively course, and may include a textured surface for more effective removal of plaque and debris. Other flosses are relatively thick and spongy, or expand upon use in order to more effectively remove plaque and debris from particularly large interdental spaces. While the relatively thin and smooth flosses used with disposable flossers provide adequate durability and ease of use, many dentists recommend the use of textured or spongy floss for a more effective cleaning.

### SUMMARY OF THE INVENTION

In some aspects, the invention provides a dental cleaning device that includes a body and a length of thread. The body includes a first end defining a handle and a second end defining first and second arms. Each of the arms includes a distal end, and the distal ends are spaced apart from one another. The length of thread is coupled to and extends between the distal ends of the arms. The thread includes a first portion having a first texture, and a second portion having a second texture that is different from the first texture.

In other aspects, the invention provides a method of making a dental cleaning device. The method includes applying tension to a length of thread to reduce at least one cross-sectional dimension of the length of thread. The length of thread includes a first portion and a second portion. The method also includes bonding the first portion of the length of thread while it is under tension, and then releasing the tension, which allows the second portion to return to an original cross-section while the bonded first portion maintains the at least one reduced cross-sectional dimension. The first and second portions join one another to define a boundary. The method also includes advancing the length of floss into a mold cavity such that the length of thread extends between a pair of mold cavity chambers that are configured to form arm portions of the dental cleaning device. The advancement of the length of thread is controlled to position the boundary between the mold cavity chambers. The mold cavity is closed and polymer is injected into the mold cavity. The polymer is allowed to cool, thereby forming a dental cleaning device body including the arm portions. The mold cavity is then opened to release the cleaning device body and at least a portion of the length of thread.

In other aspects, the invention provides a dental cleaning device including an injection-molded body that has a first end having a handle and a second end having a first arm and a second arm spaced from the first arm. The device also includes a length of floss extending between the first and second arms. The length of floss includes a first portion having an end that is overmolded by the first arm, and a second portion having an end that is overmolded by the second arm. The first and second portions extending toward one another and meet at a boundary between the two arms. The first portion and second portions have different textures.

### BRIEF DESCRIPTION OF THE DRAWINGS

FIG. 1 illustrates a disposable flosser embodying the invention and including multi-texture dental floss.

FIG. 2 is an enlarged view of a portion of the flosser of FIG. 1.

FIG. 3 is a schematic view of a method for manufacturing the multi-texture dental floss used in the flosser of FIG. 1.

FIG. 4 is an enlarged view similar to FIG. 2 showing a portion of an alternative embodiment of the flosser of FIG. 1.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways.

### DETAILED DESCRIPTION

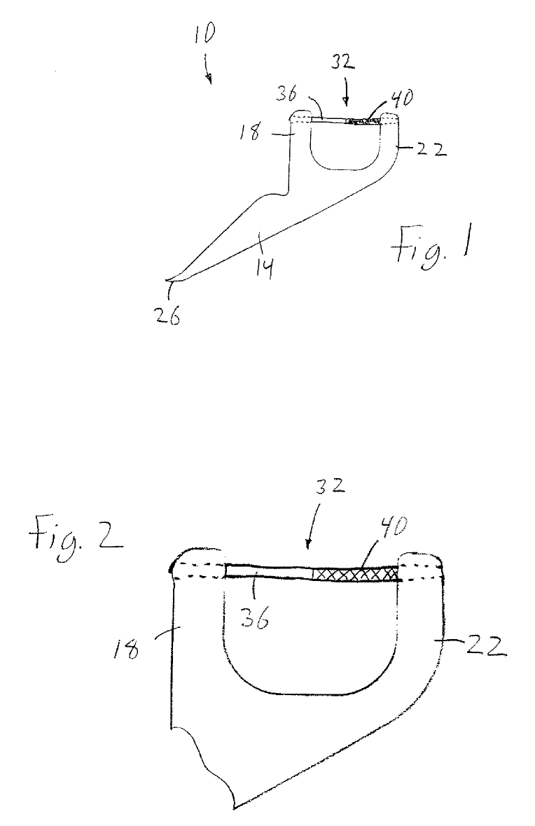

FIG. 1 illustrates a disposable dental flosser 10 embodying the invention. The flosser 10 includes a handle 14 and a pair of spaced apart arms 18, 22. In the illustrated embodiment, a distal end of the handle 14 defines a pick 26 that can be used for removing plaque or other debris from the gum line or from the spaces between teeth. The flosser 10 also includes a length of multi-texture floss 32 extending between the arms 18, 22.

With reference also to FIG. 2, the multi-texture floss 32 includes a first segment 36 that is relatively smooth, and a second segment 40 that is textured. The smooth segment 36 is provided to allow the floss 32 to be more easily manipulated through the relatively narrow space between the crowns of adjacent teeth. The textured segment 40 is provided so that once the floss 32 has been manipulated into the interdental space adjacent the gum line, the textured portion can be manipulated within the interdental space for removal of plaque and debris. The flosser thereby provides the ease of use generally associated with a smooth floss with the enhanced plaque and debris removal qualities associated with a textured floss in a single disposable flosser. In the illustrated embodiment, the first segment of floss 36 is positioned adjacent the arm 18, and the second segment of floss 40 is positioned adjacent the arm 22, however this arrangement could be reversed, if desired.

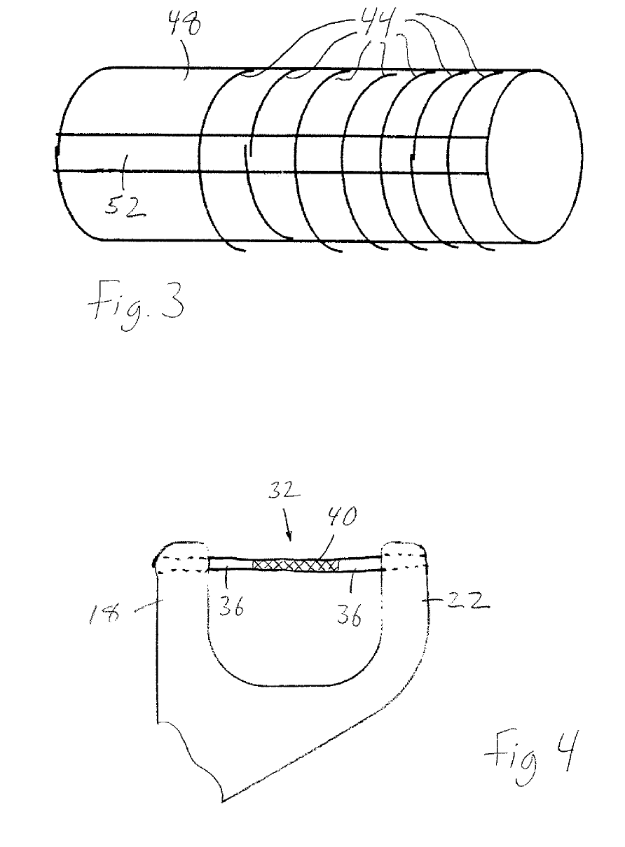

FIG. 3 schematically illustrates a first method for making the above-described multi-texture floss 32. The method includes applying tension to a length of floss 44 and winding the taught length of floss 44 around a drum 48. Applying tension to the floss 44 reduces the cross-sectional area and corresponding cross-sectional dimensions of the floss 44. The tension also draws individual floss fibers more closely together, thereby smoothing peaks and valleys that may be present in, for example, a woven floss.

The drum 48 is selected to have a circumference that is substantially equal to the length of floss that will extend between the arms 18, 22 of the flosser. In some embodiments that length will include one first segment 36 and one second segment 40 of the finished multi-texture floss 32. After a suitable length of taught floss 44 has been wound around the drum 48, an adhesive is applied to a section 52 of the drum 48 and thus to the floss 44 by rolling, spraying, or otherwise applying the adhesive in an axial direction from one end of the drum 48 to the other. One example of a suitable adhesive includes cyanoacrylate, however other adhesives may also be used. In some embodiments, the adhesive is applied to the drum 48 and floss 44 in an approximately one-half to one inch wide strip, depending at least in part upon the size of the flosser 10 for which the floss 44 is intended, and the number of smooth and textured segments 36, 40 that are desired between the arms 18, 22 of the flosser 10. For the flosser 10 of FIGS. 1 and 2, the length of the first segment 36 and the length of the second segment 40 are substantially equal, as such, the adhesive may be applied to cover the floss extending along approximately one-half of the circumference of the drum 48.

After the adhesive has set, the floss 44 is unwound from the drum 48. As the floss 44 is unwound the tension that was previously applied to the floss to reduce its cross-sectional area is relieved and the sections of floss that did not receive adhesive return to their original size, shape, and texture. These sections become the textured sections 40 of the finished multi-texture floss 32. However, the portions of the floss 44 to which the adhesive was applied maintain the reduced cross-sectional area and reduced cross-sectional dimensions associated with applying tension to the floss. The surface of the floss is also more uniform than before the above-described processing as a result of the bonding and smoothing properties provided by the adhesive. These portions become the smooth segment 36 of the finished multi-texture floss 32.

It should be appreciated that instead of applying a single strip of adhesive to the floss 44 wound upon the drum 36, multiple strips of adhesive could also be applied, resulting in multiple smooth and textured segments 36, 40 for each individual winding of floss 44. In this regard, the circumference of the drum 48 and the number of adhesive applications may be selected to meet the demands of a particular manufacturing process, or to provide a floss configuration for a particular flosser.

Another method for making the above-described multi-texture floss 32 includes the use of sonic welding. In this method, a length of floss is advanced between upper and lower dies of a sonic welding device. The length of floss is then placed under tension, thereby reducing its cross-sectional area and cross-sectional dimensions as described above. With the floss under tension, the upper and lower dies are closed and the portion of the floss between the dies is sonically welded. The sonic welding bonds the floss fibers together such that, once the dies are opened and tension on the floss is removed, the sonically welded portion of floss maintains its reduced cross-sectional area and reduced cross-sectional dimensions. The sonically welded portion of floss therefore becomes a smooth segment 36 of the finished multi-texture floss 32, and the untreated portions of floss on either side of the sonically welded portion of floss become textured segments 40 of the finished multi-texture floss 32. In some embodiments, the smooth segments 36 have a length of between about one and two inches, depending at least in part upon the size of the flosser 10. After forming one smooth segment 36, the length of floss is advanced to position a new portion of floss between the dies of the sonic welding device, and the process is repeated.

Examples of known flosses that may be manufactured using the methods described above to create the multi-texture floss 32 include GUM® brand Butler Weave® floss, GUM® brand Expanding Floss, GUM® brand Eez-Thru® floss, and GUM® brand waxed or unwaxed flosses. These and other suitable flosses may be made from one or more materials such as nylon, polytetrafluoroethylene (PTFE), ultra-high molecular weight polyethylene (UHMWPE), and polyester, among others.

For example, GUM® brand Butler Weave® floss is a braided nylon dental floss of approximately 840 denier that may be waxed or unwaxed. GUM® brand Expanding Floss is a twisted waxed nylon dental floss of approximately 700 denier that, when untreated, expands when abraded or upon contact with moisture during use. When treated to create multi-texture floss 32 using one of the methods described above, only the textured segment 40 of the Expanding Floss will expand during use. Because it may be difficult to determine which portions of the Expanding Floss have not been treated and will therefore expand during use, a colored die may be added to the adhesive that is applied during manufacturing of the multi-texture floss to clearly indicate to a user which portion of the Expanding Floss will during use. GUM® brand Eez-Thru® floss is a monofilament of polytetrafluoroethylene (PTFE) of between about 810 and 990 denier. GUM® brand waxed or unwaxed flosses are formed of twisted, shred resistant fine nylon of approximately 700 denier.

After the multi-texture floss 32 has been created, the handle 14 and arms 18, 22 of the flosser 10 are molded around a length of the floss 32. More specifically, a length of floss 32 is positioned in a mold cavity so that a boundary between the first segment 36 and the second segment 40 is positioned substantially mid-way between mold cavity chambers that will define the arms 18, 22 of the completed flosser. Proper positioning of the length of floss 32 may be accomplished by feeding the length of between sets of rollers such that the length of floss extends through the mold chambers. An optical sensing system may be utilized to detect the boundaries between first segments 36 and second segments 40, such that the rollers may be actuated to advance the length of floss 32 to the appropriate position within the mold chambers. Once the length of floss 32 is properly positioned, the mold cavity is then closed and a suitable polymer is injected into the cavity. The polymer cools and sets around the floss 32 such that when the mold cavity is opened the floss 32 is held firmly in place by the now solidified arms 18, 22 of the flosser 10. The mold cavities can be arranged so that multiple flossers 10 are simultaneously molded in spaced relation along a single length of floss 32. In that case, once the polymer has cooled the plurality of flossers 10 will be connected to one another by the length of floss. The individual flossers 10 may then be separated from one another by cutting the floss 32 between the arms 18, 22 of adjacent individual flossers.

FIG. 4 illustrates an alternative embodiment of the flosser 10. As illustrated, the floss 32 and flosser 10 of FIG. 4 are manufactured so that two relatively short first segments 36 of floss are positioned adjacent to respective ones of the arms 18, 22, of the flosser 10, and a second segment 40 extends between the two first segments 36. In some circumstances, forming the flosser 10 so that only one type of segment is overmolded during manufacturing improves the quality and consistency of the molding process. In this regard, the illustrated configuration could be reversed, whereby a first segment 36 is positioned between a pair of second segments 40 that are each coupled to a respective arm 18, 22.

In use, a user grasps the handle 14 and inserts the arms 18, 22 into his or her mouth. The user then positions the flosser 10 so that the first segment 36 is substantially aligned with the recess between a set of adjacent teeth, and urges the first segment 36 through the crown area of the adjacent teeth and into the interdental space adjacent the gum line. The user then slides the floss 32 through the interdental space to extract the first segment 36 from the interdental space and bring the second segment 40 into contact with the teeth and gums surrounding the interdental space. The user than manipulates the flosser 10 to remove plaque and other debris from the interdental space using the second segment 40. To remove the flosser from the interdental space, the user slides the floss 32 through the interdental space to extract the second segment 40 from the interdental space and bring the first segment 36 into alignment therewith. The user may then manipulate the flosser 10 to urge the first segment 36 out from between the adjacent teeth and repeat the process on another set of adjacent teeth. Thus, the first segment 36 is utilized during insertion and withdrawal of the floss 32 into/from the interdental space, and the second segment 36 is utilized while the floss 32 is positioned in the interdental space for the removal of plaque and other debris therefrom.

What is claimed is:

1. A dental cleaning device comprising:
a body, the body including a first end defining a handle and a second end defining first and second arms, each arm including a distal end, the distal ends being spaced apart from one another; and
a length of thread coupled to and extending between the distal ends of the arms, the thread including a first portion having a first texture, and a second portion having a second texture that is different from the first texture.

2. The dental cleaning device of claim 1, wherein the first portion includes a first cross-sectional area and the second portion includes a second cross-sectional area that is different from the first cross-sectional area.

3. The dental cleaning device of claim 1, wherein the body is formed of injection-molded polymer, wherein the first portion is overmolded by and extends from the first arm toward the second arm, wherein the second portion is overmolded by and extends from the second arm toward the first arm, and wherein the first and second portions join one another between the first and second arms.

4. The dental cleaning device of claim 3, wherein the first and second portions join one another substantially mid-way between the first and second arms.

5. The dental cleaning device of claim 1, wherein the first portion includes a first segment coupled to and extending from the first arm toward the second arm, and a second segment coupled to and extending from the second arm toward the first arm, and wherein the second portion extends between the first segment and the second segment.

6. The dental cleaning device of claim 1, wherein the second portion is expandable in response to abrasion, and wherein at least one of the first portion and the second portion is treated to have a different color than the other of the first portion and the second portion.

7. A method of making a dental cleaning device, the method comprising:
applying tension to a length of floss to reduce at least one cross-sectional dimension of the length of floss, the length of floss having a first portion and a second portion;
bonding the first portion of the tensioned length of floss;
releasing the tension from the length of floss, thereby allowing the second portion to return to an original cross-section while the bonded first portion maintains the at least one reduced cross-sectional dimension, the first and second portions joining one another to define a boundary;
advancing the length of floss into a mold cavity such that the length of floss extends between a pair of mold cavity chambers that are configured to form arm portions of the dental cleaning device;
controlling advancement of the length of floss to position the boundary between the mold cavity chambers;
closing the mold cavity;
injecting polymer into the mold cavity;
allowing the polymer to cool to form a dental cleaning device body including the arm portions; and
opening the mold cavity to release the cleaning device.

8. The method of claim 7, wherein bonding the portion of the tensioned length of floss comprises applying adhesive to the portion of the tensioned length of floss.

9. The method of claim 7, wherein bonding the portion of the tensioned length of floss includes sonically welding the length of floss.

10. The method of claim 7, further comprising sensing advancement of the length of floss into the mold cavity to detect a position of the boundary relative to the mold cavity.

11. The method of claim 7, wherein sensing advancement of the length of floss includes optically sensing advancement of the length of floss.

12. The method of claim 7, wherein controlling advancement of the length of floss includes controlling advancement of the length of floss to position the boundary substantially mid-way between the mold cavity chambers.

13. The method of claim 7, wherein the second portion is expandable in response to abrasion, the method further comprising treating at least one of the first portion and the second portion to have a different color than the other of the first portion and the second portion.

14. A dental cleaning device comprising:
an injection-molded body, the body including a first end including a handle and a second end including a first arm and a second arm spaced from the first arm; and
a length of floss extending between the first and second arms, the length of floss including a first portion having an end that is overmolded by the first arm, and a second portion having an end that is overmolded by the second arm, the first and second portions extending toward one another and meeting at a boundary between the two arms, the first portion having a first texture and the second portion having a second texture that is different from the first texture.

15. The dental cleaning device of claim 14, wherein the first portion includes a first cross-sectional area and the second portion includes a second cross-sectional area that is different from the first cross-sectional area.

16. The dental cleaning device of claim 14, wherein the boundary is positioned substantially mid-way between the first and second arms.

17. The dental cleaning device of claim 14, wherein the second portion is expandable in response to abrasion, and wherein at least one of the first and second portions is treated to have a different color than the other of the first and second portions.
